(19) United States
(12) Patent Application Publication
(10) Pub. No.: US 2026/0361804 A1
(43) Pub. Date: Nov. 12, 2026

(54) METHOD FOR STORING VALIDATION DATA FOR VALIDATION OF SYSTEMS FOR PROCESSING LARGE AMOUNTS OF DATA

(71) Applicant: Robert Bosch GmbH, Stuttgart (DE)

(72) Inventor: Claus SPIZIG, Stuttgart (DE)

(21) Appl. No.: 19/454,941

(22) Filed: Jan. 21, 2026

(30) Foreign Application Priority Data
Jan. 22, 2025 (DE) 10 2025 102 276.3

(51) Int. Cl. H04L 69/04; H04L 67/12

(52) U.S. Cl. CPC H04L 69/04; H04L 67/12

(57) ABSTRACT

A method for storing validation data in a data storage system. Validation data are provided for the validation of systems for processing large amounts of data. The data storage system is configured to provide the validation data for the validation of at least one system for processing large amounts of data. The validation data include, at least partially, data recorded by sensors. The method includes receiving the validation data; ascertaining at least one statistical property of the received validation data; performing a compression of the validation data to generate compressed validation data using a lossy compression method; ascertaining at least one statistical comparison property; performing a comparison of the at least one statistical property with the at least one statistical comparison property.

### FIELD

The present disclosure relates to the validation of systems for processing large amounts of data.

### BACKGROUND INFORMATION

Modern systems for processing large amounts of data, such as driver assistance systems, now process a plurality of sensor data and are able to perform complex functions which are based on said sensor data and involve (sometimes huge) intervention in the interface between the driver of the vehicle and the vehicle or the vehicle functions. Such functions may include, for example, emergency braking assistance functions that intervene when an obstacle appears in road traffic.

In such systems, sensor data is often evaluated by very complex software systems. Extensive validations are regularly required before such systems can be used in the field (i.e. in regular operation). This also regularly applies if only (relatively minor) adjustments are made to already established systems.

Using the example of the driver assistance system, according to commonly applied standards, thousands of hours of regular driving operation of a vehicle with a specific driver assistance function are required to guarantee approval for the use of the relevant driver assistance function in the field. Due to the large number of driver assistance functions in use today, and in view of the complexity of these functions, this is hardly feasible. For this reason, a widespread approach today is to perform validations of driver assistance functions under certain conditions, also in simulation environments and/or by feeding stored validation data into a control unit under test, for the execution of the relevant driver assistance function. In such simulation environments or control unit test devices, a plurality of (in particular labeled) sensor data are used to test a driver assistance system and to check whether it reacts correctly in the situation represented by the sensor data. Such sensor data, which can be used in simulation environments to test driver assistance systems, are also regularly referred to as validation data. Such validation data typically need to include original sensor data as recorded in a vehicle during a test drive. Typically, the requirements for such validation data regarding their originality are significantly higher than for training data that are used “only” for training driver assistance functions. Training data are often also generated entirely synthetically. Training data are regularly also generated, for example, by adjusting data using filters, in order to generate additional training datasets. The higher requirements for validation data compared with for training data apply because validation grants the approval of driver assistance functions for use in road traffic. Validation based on validation data is therefore also performed in many cases in order to validate training of driver assistance functions or control units for driver assistance functions based on training data.

The validation of the plurality of different driver assistance systems used on the market requires entire data centers full of stored validation data.

It would be highly desirable, in order to reduce the outlay required for storing and providing such validation data, if compression methods could be used for such data. Possible methods are described, for example, in German Patent Application No. DE 10 2019 214 587 A1, U.S. Patent No U.S. Pat. No. 11,356,579 B2, and Europe Patent Application No. EP 3 185 555 A1.

However, so far it is not possible to compress such data, for validating the function of driver assistance systems, using efficient approaches. In order to meet common standards for the validation of driver assistance systems, the data used must usually correspond bit-for-bit to what is provided in the vehicle or by the sensors of the test vehicles. This means that validation data can hitherto only be compressed with loss if it is also processed with lossy compression in the vehicle in the field. In the vehicle, such compression comes with disadvantages such as additional latency for compression and decompression, no use of CRC checksums to ensure end-to-end data integrity, and costs for compression in series production.

Based on this, the an object of the present disclosure is to alleviate or at least partially solve the problems described with reference to the related art. In particular, a solution is intended to be provided that makes it possible to achieve higher levels of compression of validation data and thus to significantly reduce the outlay required to store and provide validation data.

### SUMMARY

This section describes a method for storing validation data in a data storage system, according to an example embodiment. The validation data are provided for the validation of systems for processing large amounts of data. The systems for processing large amounts of data can preferably be the driver assistance systems described above. Alternatively, the systems for processing large amounts of data can be medical systems, manufacturing systems, or systems for conducting manufacturing tests in which very high-resolution cameras are used.

Furthermore, the data storage system is designed to provide the validation data for the validation of at least one system for processing large amounts of data, the validation data comprising, at least partially, data recorded by sensors. For example, taking the example of driver assistance systems, this could involve data recorded by sensors in vehicles during test drives.

According to an example embodiment, the method comprises the following steps:
a) receiving the raw sensor data;
b) ascertaining at least one statistical property of the received raw sensor data;
c) performing a compression of the raw sensor data to generate compressed sensor data, using a lossy compression method;
d) ascertaining at least one statistical comparison property of the compressed validation data;
e) performing a comparison of the at least one statistical property with the at least one statistical comparison property, wherein the comparison checks whether a deviation between synthesized sensor data, which can be produced based on the compressed sensor data, and the raw sensor data received in step a) lies within a predetermined tolerance range, wherein the tolerance range is selected such that deviations are detected which lie within a signal noise caused by properties of at least one sensor with which the raw sensor data were recorded, wherein the tolerance range is further selected such that the distance between synthesized sensor data based on the compressed sensor data and the recorded reality is not greater than the distance between the raw sensor data received in step a) and the same reality; and
f) storing the compressed sensor data as part of the validation data in the data storage system (12), if it was ascertained in step f) that the deviation is within the predetermined tolerance range.

The at least one statistical comparison property in step d) is preferably the same property as the at least one statistical property in step b).

The lossy compression method performed in step c) is preferably in two parts, and particularly preferably comprises the following two sub-steps:
c1) performing a reduction of noise components in raw sensor data, to generate cleaned raw sensor data; and
c2) compressing the raw sensor data using a lossless reversible compression method.

In particular, in step f) the compressed sensor data are stored in the data storage system if it has been ascertained in step e) that the deviation of the at least one statistical property is within the predetermined tolerance range.

An advantage of the method according to the present disclosure lies in the possibility of obtaining sensor data as part of validation data, and in particular compressed sensor data, with significantly less effort than previously necessary, which data exhibit the same deviation and thus quality as raw sensor data usually recorded by means of the at least one sensor. In other words, this makes it possible to achieve the advantage and proof that a compressed or decompressed image does not differ more significantly from the reality than another image that was taken of the same reality with a noisy sensor. In this case, the aforementioned comparison regarding the tolerance range contributes in particular to ensuring that the sensor data are of such high quality that they are suitable for validating driver assistance systems after being stored in the data storage system. In this case, said data in particular also take account of the necessary legal requirements. Furthermore, when considering a driver assistance system, the method allows for the disadvantages of compression in the vehicle to be avoided.

According to one example embodiment of the method, the statistical comparison property is ascertained in step d) using a validated physical model of at least one sensor.

In particular, this is a validated physical model of the at least one sensor at the relevant operating point. In this case, the at least one statistical property of the sensor preferably corresponds to the at least one statistical property of the received raw sensor data. Preferably, the at least one statistical comparison property corresponds to a property that synthetic sensor data that were reconstructed based on the compressed validation data also have.

A validated physical model of the at least one sensor was preferably validated against the at least one sensor according to specified standards, in order to provide evidence that statistical comparison properties ascertained with the validated physical model correspond to the statistical properties of the sensor.

According to an example embodiment, it is particularly preferred if operating data from the at least one sensor are applied to the validated physical model for ascertaining the statistical comparison property.

For this purpose, the operating data of the at least one sensor are preferably ascertained to set the relevant operating point of the at least one sensor in the validated physical model. These operating data preferably correspond to the raw sensor data.

Furthermore, it can be advantageous if the at least one statistical property and the at least one statistical comparison property are each a distribution of gray-scale values or brightness values in the received raw sensor data.

This refers in particular to image data (possibly individual images) that are contained in the raw sensor data. In particular, the at least one statistical property and the at least one comparison property may be a standard deviation of the gray-scale values or the brightness values. Another statistical property that can be considered within the framework of the at least one statistical property can be an average gray-scale value/brightness value of the raw sensor data (in particular of a single image contained in the raw sensor data). Preferably, the at least one statistical property is ascertained across all pixels of the raw sensor data, for example designed as an image, so that each pixel is reflected in the at least one statistical property and is evaluated via the at least one statistical property.

According to an example embodiment, it is particularly preferred if the raw sensor data were recorded with at least one image, ultrasound, lidar and/or radar sensor, preferably with at least one camera.

In the example of the driver assistance system, the raw sensor data can be recorded, for example, during test drives. The advantage of this embodiment is that the described method is applicable to different types of sensors and thus to different raw sensor data. Furthermore, the raw sensor data from different sensor types allow for different types of data to be collected and made available for validation, which overall increases the quality of the method and thus the generated validation data containing compressed sensor data.

The reception of raw sensor data in step a) describes in particular the process by which a device designed to carry out the described method receives the validation data or the raw sensor data from the sensor(s) used. The device can, for example, be carried in a vehicle used to carry out the described method. Further steps of the described method can also be carried out in such a device—in particular steps b), c), d) and e). If necessary, the generation of the raw sensor data with the sensor(s) can also be part of the method, such that the reception of raw sensor data in step a) can in particular also include the generation of raw sensor data using at least one sensor. These raw sensor data can then be processed directly using the described method. In variants, it is also possible that the raw sensor data was temporarily stored before step a) and then “received” from a buffer in step a).

According to another example embodiment, the validation data include, in addition to the sensor data, further data that were recorded in the system in parallel with the raw sensor data. In the example of the driver assistance system, the further data can be recorded in the vehicle during test drives. Such further data could include, for example, interior data about the state of the driver and/or the vehicle's occupants. For example, the data could be image data from an interior camera that records the driver's level of concentration. By using these additional data, the quality of the validation data can be further improved.

It may furthermore be advantageous if, according to one embodiment, the tolerance range used in step e) is selected such that deviations are detected which lie within a shot noise of raw sensor data received in step a).

The term “shot noise” within the meaning of the present disclosure can be understood as a specific noise pattern that arises from the conversion of photons into electrons in a sensor and changes the pixel value according to a Poisson distribution, the magnitude of the change depending on the exposure intensity.

This example embodiment makes it possible to ensure that the compressed sensor data are of sufficient quality to allow for synthesized sensor data to be (later) generated therefrom.

It is furthermore advantageous if the at least one sensor for ascertaining the raw sensor data has a characteristic according to which the at least one sensor switches between different exposure times per pixel depending on the incidence of light, the tolerance range used in step e) and/or the comparison property ascertained in step d) being established taking this characteristic into account.

This example embodiment is based on the approach that the aforementioned tolerance range takes into account pixels with varying brightness or darkness and can therefore be adapted more precisely to the respective raw sensor data. Applying operating data of the at least one sensor to a validated physical model makes it possible to take into account the different exposure times for the creation of the validated physical model.

Furthermore, it is preferred if, by adhering to the tolerance range used in step e), it is ensured, for each pixel of sensor data in the validation data, that the synthesized sensor data ascertained from the validation data stored in step g) are just as close to the reality as original raw sensor data that were received in step a).

This criterion ensures that the sensor data ascertained from the validation data stored in step f) can be considered a direct representation or equivalent to the raw sensor data, thus allowing them to be used for the validation of the at least one system. This is possible at any arbitrarily small and different point in time, which means that the data can also be used for checking safety-critical and/or AI-based systems, where higher safety levels and requirements apply than for “pure” comfort systems.

A further advantage is that, by checking the compliance with the tolerance range for each pixel, use is also possible in systems that are susceptible to the smallest changes in noise behavior. This ensures the applicability, described above, of the method in the case of safety-critical and/or AI-based driver assistance systems, as a result of which the sensor data ascertained and stored in the validation data are usable for a wider range of systems.

Furthermore, according to an example embodiment, if the system is a driver assistance system, it is preferred that at least steps a) to e) are carried out in a vehicle during a test drive for recording raw sensor data for the creation of validation data. In addition, not only test drives but rather also normal journeys, for example by employees who have a company car, can be used for the aforementioned creation of validation data. This increases the amount of available validation data that can be used to advantage for the validation of the at least one driver assistance system.

In order to store the validation data long-term, step g) includes transmitting the compressed sensor data as part of the validation data to a stationary data storage system. In the example of the driver assistance system, the data can be transmitted from a vehicle, for performing a test drive. Alternatively, wireless transmission of the data via a radio interface is also possible. Preferably, however, the transmission of the compressed sensor data, as part of the validation data, takes place in the form of hard drives containing the compressed sensor data, which hard drives are physically removed from the system (e.g. from a vehicle in which the method is carried out). The hard drives are then fed to the stationary data storage system. The stationary data storage system may be, for example, a stationary hard drive farm where the data are kept.

Furthermore, it is preferred if a comparison protocol which documents that the predetermined tolerance range is adhered to is created in step e), the comparison protocol being stored, in step f), together with the compressed sensor data.

The comparison protocol advantageously serves to demonstrate that the compressed validation data are suitable and approved for validation of the at least one driver assistance system.

Furthermore, according to an example embodiment, a method for validating a driver assistance system is specified, said method comprising the following steps;
a. receiving validation data comprising compressed sensor data from a data storage system;
b. creating synthesized sensor data from the compressed sensor data,
c. performing tests for validating the driver assistance system based on the validation data and the synthesized sensor data,
   wherein the validation data received in step a) were stored in the data storage system according to the method described above.

This section also describes a system for validating at least one driver assistance system, which validation system is configured to perform the method described above.

The advantages and preferred embodiments set out with regard to the methods are also to be applied analogously to the system, and vice versa.

The solution presented here and its technical environment are explained in more detail below with reference to the figures. It should be noted that the present disclosure is not intended to be limited by the example embodiments shown. In particular, unless explicitly shown otherwise, it is also possible to extract partial aspects of the facts explained in the figures and to combine them with other components and/or findings from other figures and/or the present description.

### BRIEF DESCRIPTION OF THE DRAWINGS

FIG. 1 shows a method for storing validation data using the example of a driver assistance system, in which a direct comparison of the received data and synthesized data is carried out.

FIG. 2 shows a first variant of the method described here, in which static properties of raw sensor data are investigated;

FIG. 3 shows a second variant of the method described here, in which statistical properties of raw sensor data are investigated.

FIG. 4 shows a method for validating a system for processing large amounts of data, using the example of a driver assistance system, with such validation data, according to an example embodiment.

In the figures, the same or functionally identical components are always provided with the same reference signs.

### DETAILED DESCRIPTION OF EXAMPLE EMBODIMENTS

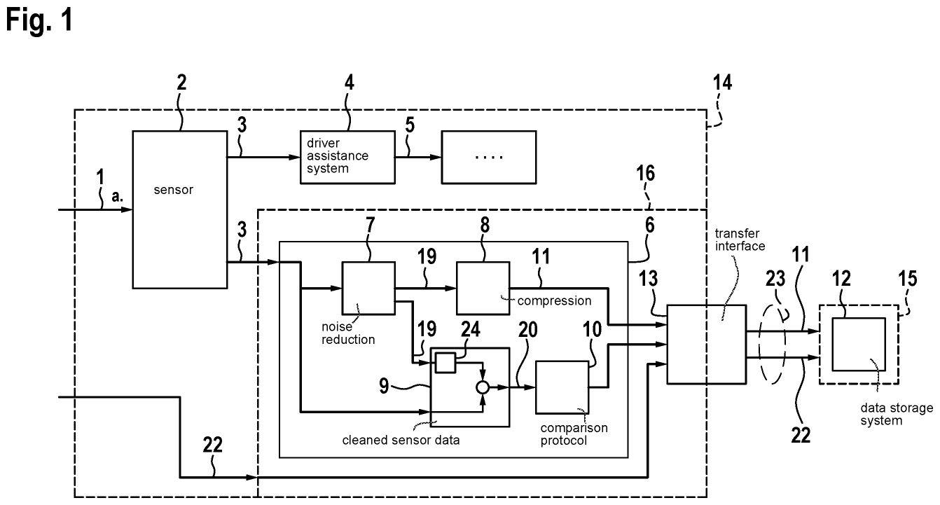

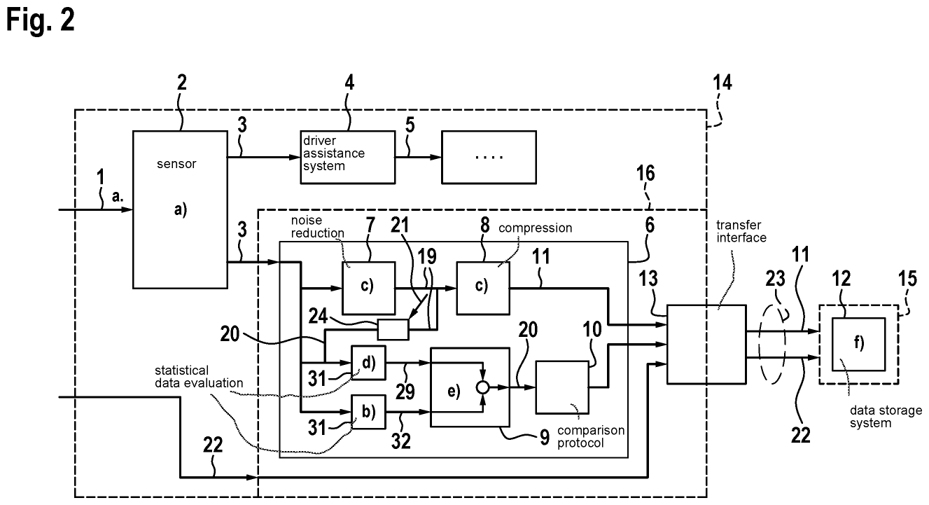

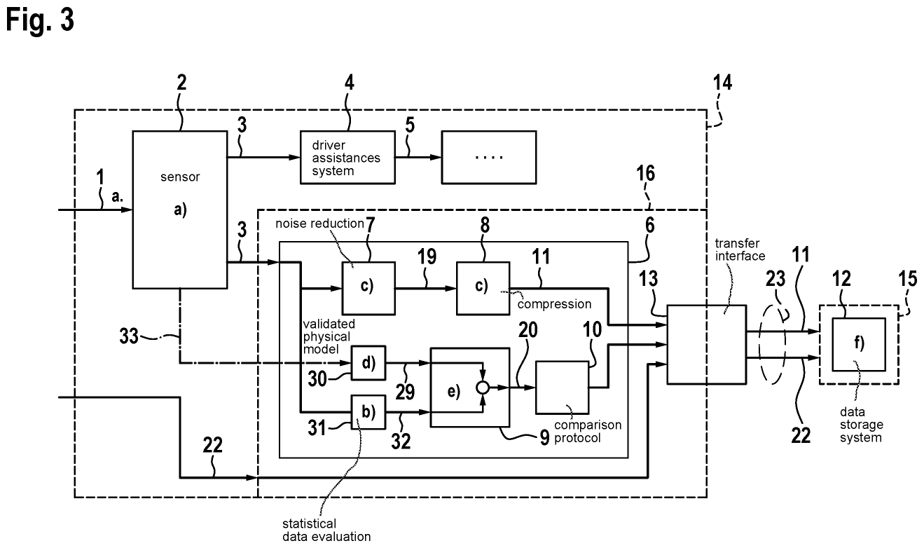

FIG. 1 shows a block diagram of a described method for providing validation data. FIG. 1 will be explained first here. FIGS. 2 and 3 show the method described here as a development of the method presented according to FIG. 1. The explanation of FIGS. 2 and 3 will in each case address differences compared to FIG. 1 and between FIGS. 2 and 3, respectively. The explanations for FIG. 1 thus also apply accordingly (to this extent) to FIGS. 2 and 3.

In this method, the real environment 1 is detected by a sensor 2. In this case, the sensor 2 can for example be an image, ultrasound, lidar and/or a radar sensor. Preferably, the sensor 2 is a camera that records image data from the real environment 1 as raw sensor data 3. However, the sensor 2 can also be a sensor in a medical system (e.g. a diagnostic system), which sensor captures a large amount of data that are used, for example, for medical diagnostic purposes. In principle, the method described here is suitable for providing validation data for a very wide variety of systems for processing large amounts of data, the method being explained here using driver assistance systems as an example.

The real environment 1 recorded by the sensor 2 is transmitted in the form of the raw sensor data 3 to a driver assistance system 4, where it can be used for a driver assistance function 5. In addition, the raw sensor data 3 also undergo compression 6 in order to store them as compressed sensor data 11, as part of validation data 23, by means of a transfer interface 13 in a data storage system 12 of a data center 15. The transfer interface 13 can be a radio interface. Alternatively, the storage can also take place without transfer by means of the transfer interface 13, on the data storage system 12, e.g. a hard drive. For example, a hard drive containing data can be (physically) removed from a test vehicle and (physically) taken to a data center for reading into the data storage system 12.

In parallel, further data 22 can also be transferred to the radio interface 13, which data are then stored in the form of validation data 23 on the data storage system 12 in the data center 15. Such further data 22 can, for example, be metadata regarding the sensor data. Such further data 22 can in particular be any type of data that can be used to label the sensor data. Alternatively, the additional data 22 can also be transferred to the data center 15 in the form of a hard drive, as described above.

This way of providing validation data enables a better solution compared to the related art, in terms of storage space and effort.

According to FIG. 1, a method for compressing the validation data (or the raw sensor data 3 in the validation data) is described, on which the method described here is based. To better understand the method described here, the method according to FIG. 1 will first be explained here.

As part of the compression process 6, a noise reduction 7 is first carried out, which is applied to the raw sensor data 3. The cleaned sensor data 19 available after the noise reduction 7 subsequently undergo a reversible lossless compression 8. The compression of the raw sensor data 3 is therefore preferably carried out in two steps. The noise reduction 7 is a first step, in which a loss of information occurs in the raw sensor data 3, in which loss of information the noise is removed. The lossless compression 8 is a second step.

In addition to the compression 8, the cleaned sensor data 19 are fed to a comparator 9. Part of the comparator 9 is a synthesizer 24, which adds synthesized noise 21 to the cleaned sensor data 11. Subsequently, the cleaned sensor data 19 (including the added synthesized noise 21) are compared with the raw sensor data 3, and a comparison protocol 10 is created. The comparison protocol 10 shows how closely the cleaned sensor data 19, to which the noise has been added, correspond to the originally recorded raw sensor data 3. In other words, the comparison protocol 10 indicates whether a predetermined tolerance range has been adhered to. The comparison protocol 10 is preferably subsequently also stored in the data storage system 12 of the data center 15.

This approach was developed according to the method for compressing the validation data (or the raw sensor data 3 in the validation data) described in FIGS. 2 and 3 and discussed here. In particular, a procedure is presented according to which the computational effort for carrying out the comparison in the comparator 9 is significantly reduced.

The aim of the described procedure is, in particular, to be able to demonstrate, through the comparison protocol 10, that the synthesized sensor data 20 created on the basis of the compressed sensor data 11 or on the basis of the validation data 23 are of the same quality as if the complete raw sensor data 3 acquired according to step a) were used without intermediate compression 6 and noise reduction 7.

The method described here is based on the finding that this proof does not have to be provided by a direct comparison of the raw sensor data 3 and the synthesized sensor data 20, but rather it is also possible to compare statistical properties 32 of the raw sensor data 3 and the synthesized sensor data 20, in order to provide this proof. Such statistical properties 32 of the raw sensor data 3 are generated with the statistical data evaluation 31, in order to compare them in the comparator 9 with Statistical comparison properties 29, and to be able to apply a comparison protocol 10. The comparison protocol 10 can be used to demonstrate that the synthesized sensor data 20/validation data created on the basis of the compressed sensor data 11/validation data are of the same quality as if the complete acquired raw sensor data 3 were used without intermediate compression 6 and noise reduction 7.

FIGS. 2 and 3 show two different approaches with which at least one statistical comparison property 29, in particular a plurality of statistical comparison properties 29, can be ascertained. The individual method steps a) to f) are assigned, in FIGS. 2 and 3, to the respective components with which the individual method steps are carried out.

According to the approach shown in FIG. 2, the cleaned sensor data 19/validation data are fed to a synthesizer 24 which adds a synthesized noise 21. This results in synthesized sensor data 20. Using a statistical data evaluation 31, at least one statistical comparison property 29 is then generated, which can be used to carry out the comparison with the comparator 9.

In parallel, the raw sensor data 3 are also fed to a statistical data evaluation 31. Here, at least one statistical property 32 of the raw sensor data 3 is then ascertained. The ascertained at least one statistical property 32 can then also be used to carry out the comparison using the comparator 9. For this purpose, the at least one statistical property 32 and the at least one statistical comparison property 29 are fed to the comparator 9. Preferably, the at least one statistical property 32 corresponds to the at least one statistical comparison property 29, so that a meaningful comparison can take place. In the comparator 9, a check is now performed to determine whether a deviation between synthesized sensor data 20, which can be produced based on the compressed sensor data/validation data 11, and the received validation data (or the raw sensor data 3 in the validation data) lies within a predetermined tolerance range. Here, the tolerance range is selected such that deviations are detected which lie within a signal noise caused by properties of at least one sensor 2 with which validation data were recorded, the tolerance range further being selected such that the distance between the synthesized sensor data 20 and the recorded reality is not greater than the distance between the raw sensor data 3 received in step a) in the validation data) and from the same reality.

After the comparison, a comparison protocol 10 is created, which indicates whether and that the tolerance range has been adhered to. The comparison protocol 10 is preferably subsequently also stored in the data storage system 12 of the data center 15.

The approach set out in FIG. 3 is simplified even further for practical implementation. The at least one statistical comparison property 29 is created here using a validated physical model 30 of the sensor 2. Using the validated physical model 30, it is ascertained what type and extent of noise 2 is introduced into the raw sensor data 3 by the sensor 2. Thus, according to the variant according to FIG. 3, it is ultimately checked whether the noise removed from the raw sensor data 3 by means of the noise reduction 7 corresponds in type and extent to noise that entered the raw sensor data 3 through sensor 2.

By ascertaining the at least one statistical comparison property 29 using the validated physical model 30 of the sensor 2, a significant simplification of the practical implementation is achieved, compared to the approach explained in FIG. 2, since no statistical data evaluation 31 of the cleaned sensor data 19/validation data fed to a synthesizer 24 is necessary. Likewise, the addition of the synthesized noise 21 is omitted.

Preferably, the validated physical model 30 receives operating data 33 of the at least one sensor 2 as an input variable. The validated physical model 30 with the operating data 33 of the at least one sensor 2 is particularly preferred, in order to be able to replicate the noise behavior of the sensor 2 for the creation of the statistical comparison property 29.

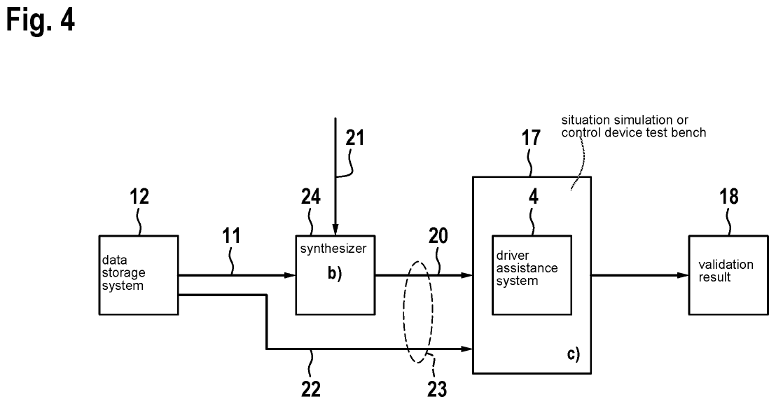

The operating data 33 can in particular be brightness values of the data (images) captured by the sensor. The operating data 33 can in particular also correspond to the raw sensor data 3, preferably (only) gray-scale values/brightness values in the raw sensor data 3 then being used to ascertain the statistical comparison property 29, by the validated physical model. This particularly preferably takes place repeatedly on a regular basis (particularly preferably for each and/or for a plurality of images contained in the raw sensor data), individually in each case. Further preferably, this takes place even pixel-by-pixel for each pixel and/or for pixel groups of images, individually in the raw sensor data. This allows different exposure times of pixels within an image to be taken into account in the raw sensor data for ascertaining the at least one statistical comparison property. FIG. 4 is a block diagram of a method for validating a system for processing large amounts of data, using the example of a driver assistance system with such validation data obtained according to the method explained with reference to FIGS. 1, 2 and 3. Steps b. and c. ) of this method are marked in FIG. 4. Step a. substantially corresponds to the method for storing validation data, explained above with reference to FIG. 1 to 3. Step a. is accordingly shown in FIG. 1 to 3.

In order to validate a system for processing large amounts of data, the validation data 23 stored in the data storage system 12 are received. The next step involves creating 24 synthesized sensor data 20 from the compressed sensor data 11 in the validation data 23. This is done by adding a synthesized statistical property 21, for example a synthesized gray-scale value, a synthesized distribution of gray-scale values, or a synthesized noise. The synthesized sensor data 20 correspond, in quality sufficient for validation, to the raw sensor data 3, which are also always noisy, for example.

The sensor data 20 “edited” or synthesized in this way are then fed into a situation simulation or a control device test bench 17. The situation simulation or the control device test bench 17 serves to simulate or validate a driver assistance system 4. Here, emergency braking scenarios can be simulated, for example, and the driver assistance system 4 can be validated accordingly. In this case, the synthesized sensor data 20 are preferably data, for example image data, containing scenarios in which an emergency braking action of the driver assistance system 4 is to be initiated by said driver assistance system.

This simulation or this control device test bench then leads to a validation result 18, which indicates whether the validation of the driver assistance system 4 was successful or not, and outputs values for assessing the performance of the system.

1-16. (canceled)

17. A method for storing validation data in a data storage system, wherein the validation data are provided for a validation of a system for processing large amounts of data, wherein the data storage system is configured to provide the validation data for the validation of at least one system for processing large amounts of data, and wherein the validation data include, at least partially, sensor data recorded by sensors, the method comprising the following steps:
a) receiving raw sensor data;
b) ascertaining at least one statistical property of the received raw sensor data;
c) performing a compression of the raw sensor data to generate compressed sensor data using a lossy compression method;
d) ascertaining at least one statistical comparison property;
e) performing a comparison of the at least one statistical property with the at least one statistical comparison property, wherein the comparison checks whether a deviation between synthesized sensor data, which can be produced based on the compressed sensor data, and the raw sensor data received in step a) lies within a predetermined tolerance range, wherein the tolerance range is selected such that deviations are detected which lie within a signal noise caused by properties of at least one sensor with which the raw sensor data were recorded, wherein the tolerance range is further selected such that the distance between the synthesized sensor data based on the compressed sensor data and recorded reality is not greater than a distance between the raw sensor data received in step a) and the same reality; and
f) storing the compressed sensor data as part of the validation data in the data storage system when it was ascertained in step e) that the deviation is within the predetermined tolerance range.

18. The method according to claim 17, wherein the statistical comparison property is ascertained in step d) using a validated physical model of at least one sensor.

19. The method according to claim 17, wherein operating data of the at least one sensor are applied to the validated physical model for ascertaining the statistical comparison property.

20. The method according to claim 17, wherein the statistical comparison property is a statistical property of synthesized sensor data generated from the compressed sensor data generated in step c).

21. The method according to claim 17, wherein the at least one statistical property and the at least one statistical comparison property are each a distribution of gray-scale values and/or brightness values in the received raw sensor data.

22. The method according to claim 17, wherein the raw sensor data were recorded with at least one of: an image sensor, an ultrasound sensor, a lidar sensor, or a radar sensor.

23. The method according to claim 22, wherein the raw sensor data were recorded with at least one camera.

24. The method according to claim 17, wherein the validation data include further data which were recorded in the data storage system in parallel with the raw sensor data.

25. The method according to claim 17, wherein the tolerance range used in step e) is selected such that deviations are detected which are within a shot noise of raw sensor data that were received in step a).

26. The method according to claim 17, wherein the at least one sensor for ascertaining the raw sensor data has a characteristic according to which the at least one sensor switches between different exposure times per pixel depending on an incidence of light, wherein the tolerance range used in step e) and/or the at least one statistical comparison property ascertained in step d) is specified taking into account the characteristic.

27. The method according to claim 17, wherein compliance with the tolerance range used in step e), for each pixel of sensor data in the validation data, ensures that the synthesized sensor data ascertained from the validation data stored in step f) are as close to the reality as the raw sensor data that were received in step a).

28. The method according to claim 17, wherein the system for processing large amounts of data is a driver assistance system and at least steps a) to e) are performed in a vehicle during a test drive for recording raw sensor data for creation of the validation data.

29. The method according to claim 17, wherein step f) includes transmitting the compressed sensor data to a stationary data storage system.

30. The method according to claim 17, wherein the compressed sensor data from step c) are wirelessly transferred from the data storage system.

31. The method according to claim 17, wherein in step e), a comparison protocol is created, which documents that the predetermined tolerance range is adhered to, wherein the comparison protocol is stored in step f) together with the compressed sensor data.

32. A method for validating a system for processing large amounts of data, comprising the following steps;
a) receiving validation data including compressed sensor data from a data storage system;
b) creating synthesized sensor data from the compressed sensor data; and
c) performing tests to validate the system for processing large amounts of data based on the validation data and the synthesized sensor data;
wherein the validation data received in step a) were stored in the data storage system by performing:
d) receiving raw sensor data,
e) ascertaining at least one statistical property of the received raw sensor data,
f) performing a compression of the raw sensor data to generate compressed sensor data using a lossy compression method,
g) ascertaining at least one statistical comparison property,
h) performing a comparison of the at least one statistical property with the at least one statistical comparison property, wherein the comparison checks whether a deviation between second synthesized sensor data, which can be produced based on the compressed sensor data, and the raw sensor data received in step d) lies within a predetermined tolerance range, wherein the tolerance range is selected such that deviations are detected which lie within a signal noise caused by properties of at least one sensor with which the raw sensor data were recorded, wherein the tolerance range is further selected such that the distance between the second synthesized sensor data based on the compressed sensor data and recorded reality is not greater than a distance between the raw sensor data received in step d) and the same reality, and
i) storing the compressed sensor data as part of the validation data in the data storage system when it was ascertained in step h) that the deviation is within the predetermined tolerance range.

33. A system for validating a system for processing large amounts of data, the system for validating configured to carry out the following steps comprising:
a) receiving validation data including compressed sensor data from a data storage system;
b) creating synthesized sensor data from the compressed sensor data; and
c) performing tests to validate the system for processing large amounts of data based on the validation data and the synthesized sensor data;
wherein the validation data received in step a) were stored in the data storage system by performing:
d) receiving raw sensor data,
e) ascertaining at least one statistical property of the received raw sensor data,
f) performing a compression of the raw sensor data to generate compressed sensor data using a lossy compression method,
g) ascertaining at least one statistical comparison property,
h) performing a comparison of the at least one statistical property with the at least one statistical comparison property, wherein the comparison checks whether a deviation between second synthesized sensor data, which can be produced based on the compressed sensor data, and the raw sensor data received in step d) lies within a predetermined tolerance range, wherein the tolerance range is selected such that deviations are detected which lie within a signal noise caused by properties of at least one sensor with which the raw sensor data were recorded, wherein the tolerance range is further selected such that the distance between the second synthesized sensor data based on the compressed sensor data and recorded reality is not greater than a distance between the raw sensor data received in step d) and the same reality, and
i) storing the compressed sensor data as part of the validation data in the data storage system when it was ascertained in step h) that the deviation is within the predetermined tolerance range.
